(19) United States
(12) Patent Application Publication
(10) Pub. No.: US 2016/0147625 A1
(43) Pub. Date: May 26, 2016

(54) DETECTING DEVICE FOR DETECTING USB 2.0 SPECIFICATION AND ELECTRONIC APPARATUS WITH DETECTING DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: JIE MIN, Wuhan (CN); CHUN-SHENG CHEN, New Taipei (TW)

(21) Appl. No.: 14/575,828

(22) Filed: Dec. 18, 2014

(30) Foreign Application Priority Data
Nov. 20, 2014 (CN) 201410666882.5

(51) Int. Cl. G06F 11/22; G06F 11/30; G06F 13/38; G06F 13/40; G06F 13/42

(52) U.S. Cl. CPC G06F 11/2247; G06F 13/4022; G06F 13/4282; G06F 13/387; G06F 11/3051

(57) ABSTRACT

A detecting device for detecting USB specification includes a USB interface circuit, a USB 2.0 detecting circuit, and a prompting circuit. The USB interface circuit includes a USB 2.0 pin for receiving data under USB 2.0 specification, and a USB 3.0 pin coupled to a south bridge chip for receiving data under USB 3.0 specification. The USB 2.0 detecting circuit is coupled to the USB 2.0 pin. The USB 2.0 detecting circuit can send a control signal to the prompting circuit upon detecting a data exchange requirement from the USB 2.0 pin. The prompting circuit can prompt upon receiving the control signal.

### CROSS-REFERENCE TO RELATED APPLICATIONS

This application claims priority to Chinese Patent Application No. 201410666882.5 filed on Nov. 20, 2014, the contents of which are incorporated by reference herein.

### FIELD

The present invention relates to a detecting device for detecting a USB 2.0 specification and an electronic apparatus with the detecting device.

### BACKGROUND

Universal Serial Bus (USB) is an industry standard that defines the cables, connectors and communications protocols used in a bus for connection, communication, and power supply between computers and electronic apparatus. The USB 3.0 specification increases data transfer rate, decrease power consumption, increase power output, relative to USB 2.0 specification, and can be backwards-compatible with USB 2.0.

### BRIEF DESCRIPTION OF THE DRAWINGS

Implementations of the present technology will now be described, by way of example only, with reference to the attached figures.

FIG. 1 is a diagrammatic view of an embodiment of a detecting device for detecting a USB 2.0 specification.

FIG. 2 is a diagrammatic view of another embodiment of a detecting device for detecting a USB 2.0 specification.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

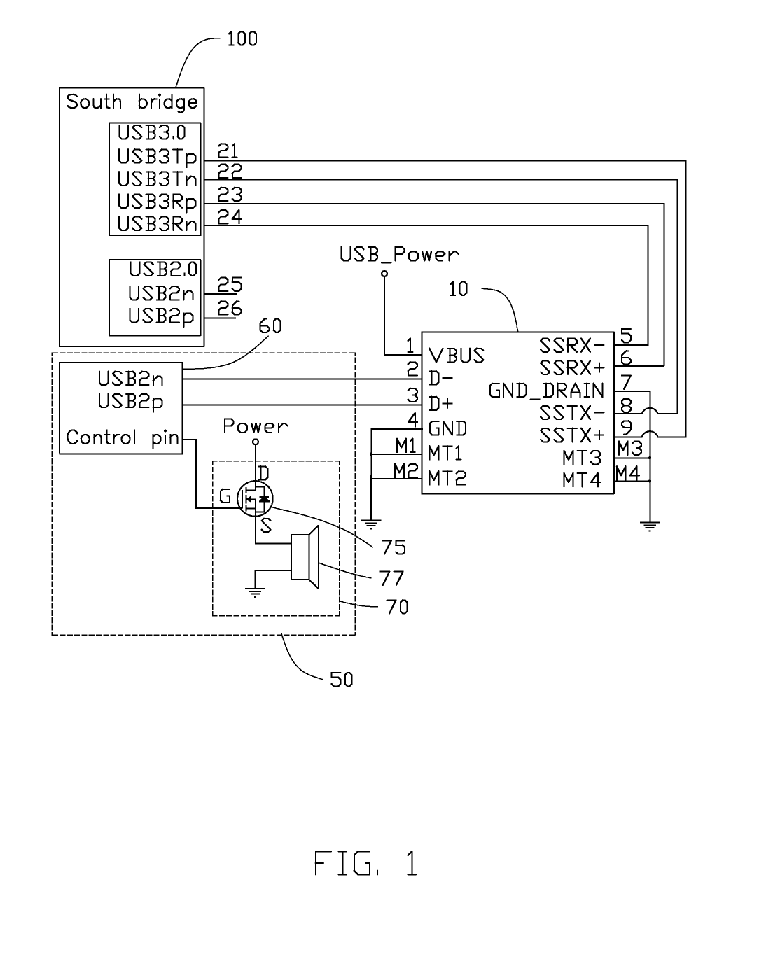

FIG. 1 illustrates an electronic apparatus in one embodiment. The electronic apparatus can detect a USB 2.0 specification of a USB storage device coupled to the electronic apparatus.

The electronic apparatus includes a south bridge 100 and a detecting circuit.

The south bridge 100 can be used to exchange data from the USB storage device. The south bridge 100 includes a USB 3.0 chip and a USB 2.0 chip. The USB 3.0 chip includes a pin 21, a pin 22, a pin 23, and a pin 24. The USB 2.0 chip includes a pin 25 and a pin 26.

The detecting circuit includes a USB interface chip 10 and a USB detecting circuit 50.

The USB interface chip 10 includes a pin 1, a pin 2, a pin 3, and a pin 4. The pin 1 is coupled to a USB power. The pin 2 and the pin 3 are one pair and are defined as USB 2.0 pins to transmit data under USB 2.0 specification. The pin 4 is grounded. When a USB storage device under USB 2.0 specification is coupled to the USB interface chip 10, the USB storage device under USB 2.0 specification can only transmit data through pin 2 and pin 3.

The USB interface chip 10 further includes a pin 5, a pin 6, a pin 7, a pin 8, and a pin 9. The pin 5 and pin 6, and the pin 8 and pin 9 are two pairs and are defined as USB 3.0 pins to transmit data under USB 3.0 specification. The pin 7 is grounded. The pin 5 and pin 6 are coupled to the pin 24 and the pin 23 of the USB 3.0 chip of the south bridge 100. The pin 8 and pin 9 are coupled to the pin 22 and the pin 21 of the USB 3.0 chip of the south bridge 100. When a USB storage device under USB 3.0 specification is coupled to the USB interface chip 10, the USB storage device under USB 3.0 specification can transmit data through the pin 5 and pin 6, and the pin 8 and pin 9.

The USB detecting circuit 50 includes a USB 2.0 detecting circuit 60 and a prompting circuit 70. The USB 2.0 detecting circuit 60 includes two input pins and a control pin. The two input pins of the USB 2.0 detecting circuit 60 are coupled to the pin 2 and pin 3. The control pin of the USB 2.0 detecting circuit 60 is coupled to the prompting circuit 70. The USB 2.0 detecting circuit 60 can detect data exchange requirement from the input pins and send a control signal through the control pin.

The prompting circuit 70 includes a Metal Oxide Semiconductor Field Effect Transistor (MOSEFT) 75 and a sound producing device 77. The MOSEFT 75 can be an N-channel MOSEFT 75. The MOSEFT 75 can control the sound producing device 77 to beep when receives the control signal from the USB 2.0 detecting circuit 60. A source electrode of the MOSEFT 75 is coupled to the sound producing device 77. A drain electrode of the MOSEFT 75 is coupled to a power. A grid electrode of the MOSEFT 75 is coupled to the USB 2.0 detecting circuit 60. A positive electrode of the sound producing device 77 is coupled to the source electrode of the MOSEFT 75. A negative electrode of the sound producing device 77 is grounded. The control signal can be a high level signal. When the grid electrode of the MOSEFT 75 receives the high level signal, the drain electrode and source electrode of the MOSEFT 75 are on. The sound producing device 77 is powered and beeps.

In use, when the USB interface chip 10 is coupled to a USB storage device. When the USB storage device works under USB 3.0 specification, the USB storage device send data exchange requirement through the pin 5 and pin 6, and the pin 8 and pin 9. The USB 2.0 detecting circuit 60 gets no data from the USB interface chip 10. When the USB storage device works under USB 2.0 specification, the USB storage device send data exchange requirement through the pin 2 and pin 3. The USB 2.0 detecting circuit 60 gets data from the USB interface chip 10 and send control signal to the prompt circuit 70. The sound producing device 77 beeps.

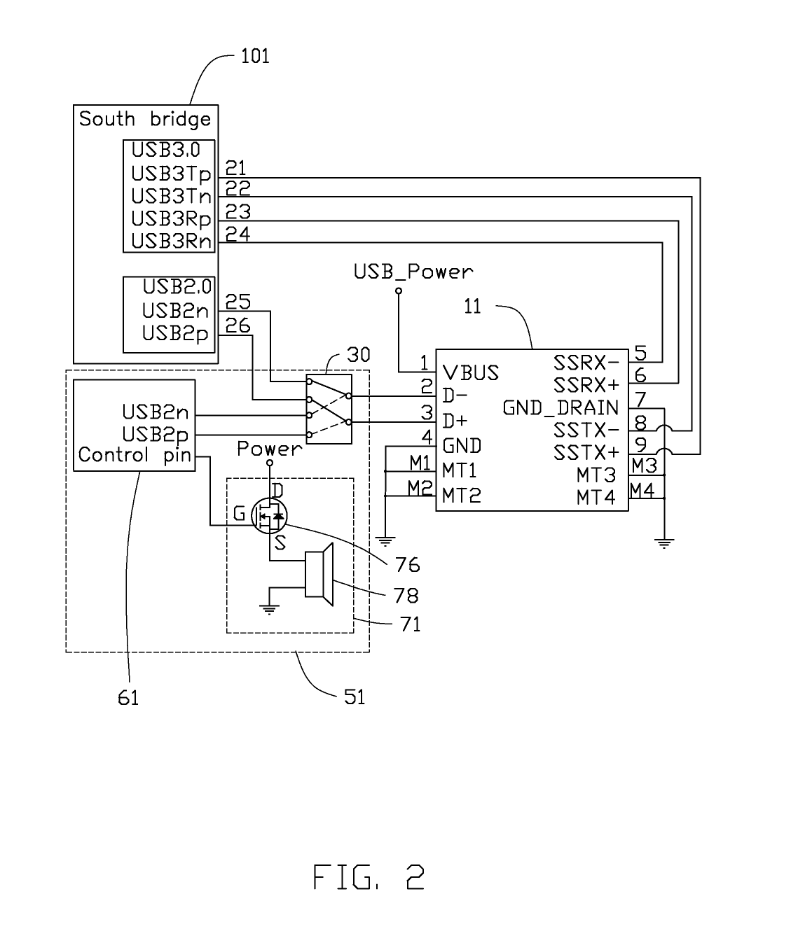

FIG. 2 illustrates an electronic apparatus in another embodiment. The electronic apparatus includes a south bridge 101 and a detecting circuit.

The south bridge 101 can be used to exchange data from the USB storage device. The south bridge 101 includes a USB 3.0 chip and a USB 2.0 chip. The USB 3.0 chip includes a pin 21, a pin 22, a pin 23, and a pin 24. The USB 2.0 chip includes a pin 25 and a pin 26.

The detecting circuit includes a USB interface chip 11 and a USB detecting circuit 51.

The USB interface chip 11 includes a pin 1, a pin 2, a pin 3, and a pin 4. The pin 1 is coupled to a USB power. The pin 2 and the pin 3 are one pair and are defined as USB 2.0 pins to transmit data under USB 2.0 specification. The pin 4 is grounded. When a USB storage device under USB 2.0 specification is coupled to the USB interface chip 11, the USB storage device under USB 2.0 specification can only transmit data through pin 2 and pin 3.

The USB interface chip 11 further includes a pin 5, a pin 6, a pin 7, a pin 8, and a pin 9. The pin 5 and pin 6, and the pin 8 and pin 9 are two pairs and are defined as USB 3.0 pins to transmit data under USB 3.0 specification. The pin 7 is grounded. The pin 5 and pin 6, are coupled to the pin 24 and the pin 23 of the USB 3.0 chip of the south bridge 100. The pin 8 and pin 9 are coupled to the pin 22 and the pin 21 of the USB 3.0 chip of the south bridge 101. When a USB storage device under USB 3.0 specification is coupled to the USB interface chip 11, the USB storage device under USB 3.0 specification can transmit data through the pin 5 and pin 6, and the pin 8 and pin 9.

The USB detecting circuit 51 includes a switch circuit 30, a USB 2.0 detecting circuit 61 and a prompting circuit 71. The switch circuit 30 is coupled to the pin 2 and pin 3 at a first terminal, and is coupled to the USB 2.0 detecting circuit 61 and the pin 25 and pin 26 of the USB 2.0 chip of the south bridge 101 at a second terminal. The switch circuit 30 can switch at the second terminal between the USB 2.0 detecting circuit 61 and the pin 25 and pin 26 of the south bridge 101. The switch circuit 30 can be switched by electronic control or manual control. The USB 2.0 detecting circuit 61 includes two input pins and a control pin. The two input pins of the USB 2.0 detecting circuit 61 are coupled to the pin 2 and pin 3. The control pin of the USB 2.0 detecting circuit 61 is coupled to the prompting circuit 71. The USB 2.0 detecting circuit 61 can detect data exchange requirement from the input pins and send a control signal through the control pin.

The prompting circuit 71 includes a MOSEFT 76 and a sound producing device 78. The MOSEFT 76 can be an N-channel MOSEFT 76. The MOSEFT 76 can control the sound producing device 78 to beep when receives the control signal from the USB 2.0 detecting circuit 61. A source electrode of the MOSEFT 76 is coupled to the sound producing device 78. A drain electrode of the MOSEFT 76 is coupled to a power. A grid electrode of the MOSEFT 76 is coupled to the USB 2.0 detecting circuit 61. A positive electrode of the sound producing device 78 is coupled to the source electrode of the MOSEFT 76. A negative electrode of the sound producing device 76 is grounded. The control signal can be a high level signal. When the grid electrode of the MOSEFT 76 receives the high level signal, the drain electrode and source electrode of the MOSEFT 76 are on. The sound producing device 78 is powered and beeps.

When to detect the USB specification of a USB storage device, a second terminal of the switch circuit 30 is switched to the USB 2.0 detecting circuit 61. When the USB storage device works under USB 3.0 specification, the USB storage device send data exchange requirement through the pin 5 and pin 6, and the pin 8 and pin 9. The USB 2.0 detecting circuit 61 gets no data from the USB interface chip 11. When the USB storage device works under USB 2.0 specification, the USB storage device send data exchange requirement through the pin 2 and pin 3. The USB 2.0 detecting circuit 61 gets data from the USB interface chip 11 and send control signal to the prompt circuit 71. The sound producing device 78 beeps.

In other embodiments, the prompt can include display or indicate light to prompt the detected USB specification.

The embodiments shown and described above are only examples. Many details are often found in the art such as the other features of a detecting device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A detecting device for detecting USB specification, comprising:
a USB interface circuit, comprising a USB 2.0 pin for receiving data under USB 2.0 specification, and a USB 3.0 pin coupling to a south bridge chip for receiving data under USB 3.0 specification;
a USB 2.0 detecting circuit coupling to the USB 2.0 pin; and
a prompting circuit;
wherein, upon detecting a data exchange requirement from the USB 2.0 pin, the USB 2.0 detecting circuit is configured to send a control signal to the prompting circuit which is configured to produce a prompt upon receiving the control signal.

2. The detecting device of claim 1, further comprising a switch circuit, wherein the switch circuit is coupled to the USB 2.0 pin at a first terminal and is coupled to the USB 2.0 detecting circuit and the south bridge at a second terminal, and the switch circuit is configured to switch between the USB 2.0 detecting circuit and the south bridge at the second terminal.

3. The detecting device of claim 2, wherein the switch circuit is switched by electronic control.

4. The detecting device of claim 2, wherein the switch circuit is switched by manual control.

5. The detecting device of claim 1, wherein the prompting circuit comprises a MOSFET and a sound producing device, and the MOSFET is configured to control the sound producing device to beep when receives the control signal.

6. The detecting device of claim 5, wherein the MOSFET is an N-channel MOSFET.

7. The detecting device of claim 6, wherein a source electrode is coupled to the sound producing device, a drain electrode is coupled to a power, and a grid electrode is coupled to the USB 2.0 detecting circuit.

8. The detecting device of claim 7, wherein the control signal is a high level signal, and when the grid electrode receives the control signal, the source electrode is connected to the drain electrode.

9. An electronic apparatus, comprising:
a south bridge;
a USB interface circuit, comprising a USB 2.0 pin for receiving data under USB 2.0 specification, and a USB 3.0 pin coupling to the south bridge chip for receiving data under USB 3.0 specification;
a USB 2.0 detecting circuit coupling to the USB 2.0 pin; and
a prompting circuit;
wherein the USB 2.0 detecting circuit is configured to send a control signal to the prompting circuit upon detecting a data exchange requirement from the USB 2.0 pin, and the prompting circuit is configured to prompt upon receiving the control signal.

10. The electronic apparatus of claim 9, further comprising a switch circuit, wherein the switch circuit is coupled to the pair of USB 2.0 pins at a first terminal and is coupled to the USB 2.0 detecting circuit and the south bridge at a second terminal, and the switch circuit is configured to switch between the USB 2.0 detecting circuit and the south bridge at the second terminal.

11. The electronic apparatus of claim 10, wherein the switch circuit is switched by electronic control.

12. The electronic apparatus of claim 10, wherein the switch circuit is switched by manual control.

13. The electronic apparatus of claim 9, wherein the prompting circuit comprises a MOSFET and a sound producing device, and the MOSFET is configured to control the sound producing device to beep when receives the control signal.

14. The electronic apparatus of claim 13, wherein the MOSFET is an N-channel MOSFET.

15. The electronic apparatus of claim 14, wherein a source electrode is coupled to the sound producing device, a drain electrode is coupled to a power, and a grid electrode is coupled to the USB 2.0 detecting circuit.

16. The electronic apparatus of claim 15, wherein the control signal is a high level signal, and when the grid electrode receives the control signal, the source electrode is connected to the drain electrode.

17. A detecting device for detecting USB specification, comprising:
a USB interface circuit, comprising a pair of USB 2.0 pins for receiving data under USB 2.0 specification, and two pair of USB 3.0 pins coupling to a south bridge chip for receiving data under USB 3.0 specification;
a USB 2.0 detecting circuit coupling to the USB 2.0 pin;
a switch circuit being coupled to the pair of USB 2.0 pins at a first terminal, being coupled to the USB 2.0 detecting circuit and the south bridge at a second terminal, and being configured to switch between the USB 2.0 detecting circuit and the south bridge at the second terminal; and
a prompting circuit;
wherein the USB 2.0 detecting circuit is configured to send a control signal to the prompting circuit upon detecting a data exchange requirement, and the prompting circuit is configured to prompt upon receiving the control signal.

18. The detecting device of claim 17, wherein the prompting circuit comprises a MOSFET and a sound producing device, and the MOSFET is configured to control the sound producing device to beep when receives the control signal.

19. The detecting device of claim 18, wherein the MOSFET is an N-channel MOSFET, a source electrode is coupled to the sound producing device, a drain electrode is coupled to a power, and a grid electrode is coupled to the USB 2.0 detecting circuit.

20. The detecting device of claim 19, wherein the control signal is a high level signal, and when the grid electrode receives the control signal, the source electrode is connected to the drain electrode.
